(19) United States
(12) Patent Application Publication
(10) Pub. No.: US 2024/0331073 A1
(43) Pub. Date: Oct. 3, 2024

(54) VEHICLE MANAGEMENT SYSTEM AND VEHICLE MANAGEMENT METHOD

(71) Applicant: HONDA MOTOR CO., LTD., Tokyo (JP)

(72) Inventor: Katsumasa Ishikawa, Wako-shi (JP)

(21) Appl. No.: 18/603,856

(22) Filed: Mar. 13, 2024

(30) Foreign Application Priority Data
Mar. 29, 2023 (JP) 2023-054021

(51) Int. Cl. G06Q 50/40; B60W 60/00; G08G 1/123

(52) U.S. Cl. CPC G06Q 50/40; B60W 60/00253; G08G 1/123

(57) ABSTRACT

A vehicle management system includes: a vehicle identification information obtaining section; a vehicle entry permission section; and a vehicle-in-site monitoring section. The vehicle identification information obtaining section is configured to obtain vehicle identification information. The vehicle identification information is for identifying the target vehicle. The vehicle entry permission section is configured to permit the target vehicle to enter the take-off and landing site when arrival of the target vehicle at a vehicle entrance gate in the take-off and landing site is recognized through authentication processing that uses the vehicle identification information. The vehicle-in-site monitoring section is configured to recognize a position of the target vehicle in the take-off and landing site and monitor movement of the target vehicle to a parking position of a target aircraft that is used for a target flight.

### INCORPORATION BY REFERENCE

The present application claims priority under 35 U.S.C. § 119 to Japanese Patent Application No. 2023-054021 filed on Mar. 29, 2023. The content of the application is incorporated herein by reference in its entirety.

### BACKGROUND OF THE INVENTION

### Field of the Invention

The present invention relates to a vehicle management system and a vehicle management method.

### Description of the Related Art

Conventionally, technology has been proposed that causes cart micromobilities to autonomously travel to a side of a boarding door of an electric vertical take-off and landing aircraft (eVTOL) that has landed and a transit point of the next transportation means such as ride-sharing vehicles in a take-off and landing site of eVTOLs to pick up and drop off passengers of the eVTOL (see, for example, Japanese Patent Laid-Open No. 2022-70117).

In the related art mentioned above, the passengers of the eVTOL use the dedicated micromobilities to move from the eVTOL to the transit point of ride-sharing vehicles or the like that are the next transportation means in the take-off and landing site, causing transfer loss time for getting on and off the micromobilities. This leaves room for improvement from the perspective of efficiency of a transfer between the aircraft and a vehicle.

The present invention has been devised in view of such background and an object of the present invention is to provide a vehicle management system and a vehicle management method that each make it possible to support an efficient transfer between an aircraft and a vehicle.

### SUMMARY OF THE INVENTION

A first aspect for achieving the object described above includes a vehicle management system including: a vehicle entry acceptance section; a vehicle identification information obtaining section; a vehicle entry permission section; and a vehicle-in-site monitoring section. The vehicle entry acceptance section is configured to receive vehicle entry request information transmitted from a user terminal that is used by a user who reserves a target flight and accept entry of a target vehicle to a take-off and landing site of the target flight. The vehicle entry request information is for requesting the entry of the target vehicle to the take-off and landing site. The vehicle identification information obtaining section is configured to obtain vehicle identification information when the vehicle entry acceptance section accepts the entry of the target vehicle to the take-off and landing site. The vehicle identification information is for identifying the target vehicle. The vehicle entry permission section is configured to permit the target vehicle to enter the take-off and landing site when arrival of the target vehicle at a vehicle entrance gate in the take-off and landing site is recognized through authentication processing that uses the vehicle identification information. The vehicle-in-site monitoring section is configured to recognize a position of the target vehicle in the take-off and landing site and monitor movement of the target vehicle to a parking position of a target aircraft that is used for the target flight.

In the vehicle management system described above, the vehicle-in-site monitoring section may be configured to monitor the movement of the target vehicle to the parking position of the target aircraft on the basis of positional information related to the target vehicle. The positional information is transmitted from the target vehicle.

In the vehicle management system described above, a route information providing section may be included. The route information providing section is configured to transmit route information to the target vehicle that enters the take-off and landing site. The route information is related to a route to the parking position of the target aircraft.

In the vehicle management system described above, an entry-prohibited area information providing section may be included. The entry-prohibited area information providing section is configured to transmit information to the target vehicle that enters the take-off and landing site. The information is related to an entry-prohibited area for the target vehicle in the take-off and landing site.

In the vehicle management system described above, when the target vehicle that enters the take-off and landing site approaches an entry-prohibited area for the target vehicle in the take-off and landing site, the vehicle-in-site monitoring section may be configured to transmit entry prohibition reporting information to the target vehicle. The entry prohibition reporting information is for reporting prohibition of entry to the entry-prohibited area.

In the vehicle management system described above, the target vehicle may have a self-driving function, and a remote guide section may be included. The remote guide section is configured to guide the target vehicle that enters the take-off and landing site to the parking position of the target aircraft by self-driving.

A second aspect for achieving the object described above includes a vehicle management method that is executed by a computer. The vehicle management method includes: a vehicle entry acceptance step of receiving vehicle entry request information transmitted from a user terminal that is used by a user who reserves a target flight and accepting entry of a target vehicle to a take-off and landing site of the target flight; a vehicle identification information obtaining step of obtaining vehicle identification information when the entry of the target vehicle to the take-off and landing site is accepted in the vehicle entry acceptance step; a vehicle entry permission step of permitting the target vehicle to enter the take-off and landing site when arrival of the target vehicle at a vehicle entrance gate in the take-off and landing site is recognized through authentication processing that uses the vehicle identification information; and a vehicle-in-site monitoring step of recognizing a position of the target vehicle in the take-off and landing site and monitoring movement of the target vehicle to a parking position of a target aircraft that is used for the target flight. The vehicle entry request information is for requesting the entry of the target vehicle to the take-off and landing site. The vehicle identification information is for identifying the target vehicle.

According to the vehicle management system and the vehicle management method described above, it is possible to support an efficient transfer between an aircraft and a vehicle.

### BRIEF DESCRIPTION OF THE DRAWINGS

FIG. 1 is an explanatory diagram of a manner in which a vehicle management system manages entry of a vehicle to a take-off and landing site;

FIG. 2 is a configuration diagram of the vehicle management system;

FIG. 3 is a first flowchart of vehicle entry management processing; and

FIG. 4 is a second flowchart of the vehicle entry management processing.

### DETAILED DESCRIPTION OF THE PREFERRED EMBODIMENTS

### 1. Manner in which Vehicle Management System Manages Entry of Vehicle

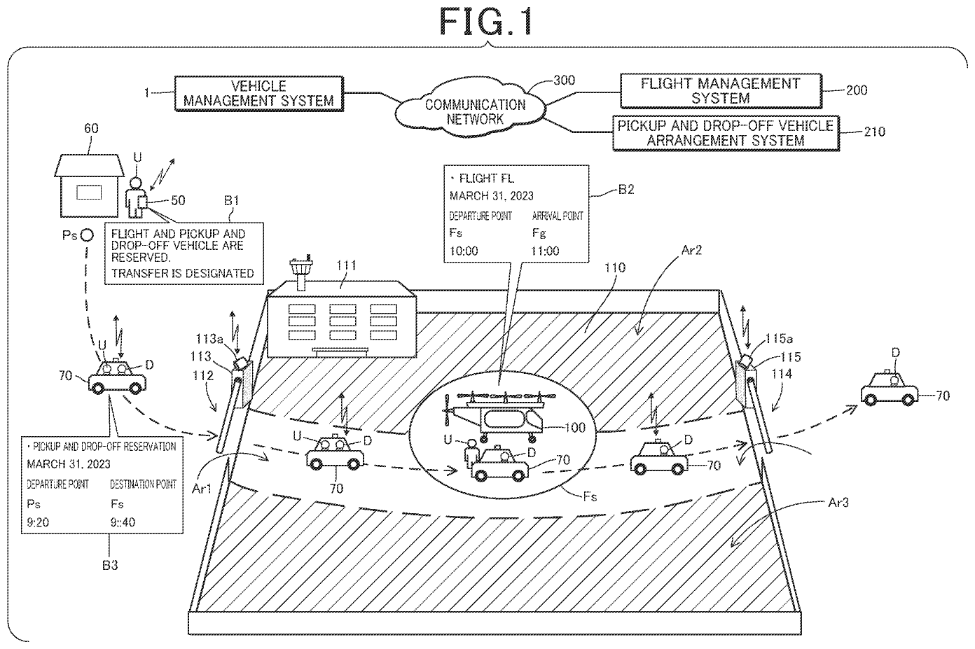

A manner in which a vehicle management system 1 according to the present embodiment manages the entry of a target vehicle 70 to a take-off and landing site 110 of a target aircraft 100 will be described with reference to FIG. 1. The target aircraft 100 is, for example, an electric vertical take-off and landing aircraft (eVTOL). The target vehicle 70 is, for example, a pickup and drop-off vehicle such as a taxi, a chauffeur-driven hired car, or a shared vehicle.

The vehicle management system 1 communicates with a flight management system 200, a pickup and drop-off vehicle arrangement system 210, a user terminal 50 used by a user U, and the target vehicle 70 through a communication network 300. The user U accesses the flight management system 200 by using a flight reservation application (application program) installed in the user terminal 50 to reserve a flight.

In addition, the user U accesses the pickup and drop-off vehicle arrangement system 210 by using a pickup and drop-off vehicle reservation application installed in the user terminal 50 to reserve a pickup and drop-off vehicle. The vehicle management system 1 executes processing of managing the entry of the target vehicle 70 to the take-off and landing site 110 when the vehicle management system 1 is provided with reservation information from the pickup and drop-off vehicle arrangement system 210 to recognize that the user U reserves a flight and a pickup and drop-off vehicle and the reservation of the pickup and drop-off vehicle designates a transfer at the departure point or the arrival point of the flight as illustrated in a speech balloon B1.

FIG. 1 exemplifies a situation in which the user U reserves a target flight FL by the target aircraft 100 illustrated in the speech balloon B1 and reserves a pickup and a drop-off by the target vehicle 70 illustrated in a speech balloon B3, and moves from a home 60 to the take-off and landing site 110 as illustrated in a speech balloon B2. The target aircraft 100 of the flight FL is scheduled to depart from a parking position Fs in the take-off and landing site 110 at 10:00.

The target vehicle 70 of the pickup and drop-off reservation is scheduled to depart from a location Ps of the home 60 of the user U at 9:20 and arrive at the parking position Fs of the target aircraft 100 for the target flight FL at 9:40. A driver D of the target vehicle 70 has the user U in the target vehicle 70 at Ps, drives to the take-off and landing site 110, enters the take-off and landing site 110 from an entrance gate 112, moves to the parking position Fs of the target aircraft 100, and drops off the user U at the parking position Fs. This allows the user U to seamlessly and efficiently transfer from the target vehicle 70 to the target aircraft 100. The driver D who drops off the user U at the parking position Fs moves to an exit gate 114 and exits from the take-off and landing site 110.

The vehicle management system 1 opens the entrance gate 112 and permits the target vehicle 70 to enter the take-off and landing site 110 when the vehicle management system 1 obtains identification information related to the target vehicle 70 from the reservation information related to the target vehicle 70 in advance and recognizes that the target vehicle 70 arrives at the entrance gate 112 through authentication processing based on a shot image or the like of a camera 113a of an entrance gate unit 113 provided to the entrance gate 112.

The vehicle management system 1 then monitors the movement of the target vehicle 70 in the take-off and landing site 110 on the basis of positional information transmitted from the target vehicle 70 until the target vehicle 70 exits from the exit gate. This makes it possible to ensure the retainment of security against permission for the entry of the target vehicle 70 that is a general vehicle to the take-off and landing site 110.

### 2. Configuration of Vehicle Management System

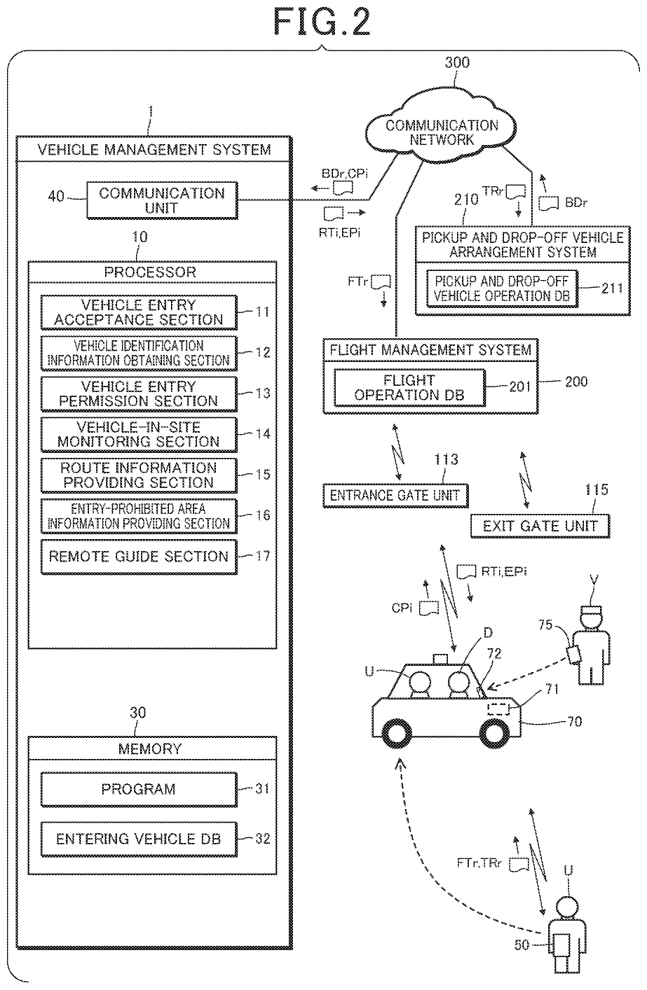

A configuration of the vehicle management system 1 will be described with reference to FIG. 2. The vehicle management system 1 is a computer system including a processor 10, a memory 30, a communication unit 40, and the like. The vehicle management system 1 performs communication through the communication network 300 as described above by using the communication unit 40.

The flight management system 200 includes a flight operation database (DB) 201 in which flight operation information indicating the operation status of a flight is recorded. The flight operation information includes reservation information related to a flight. The pickup and drop-off vehicle arrangement system 210 includes a pickup and drop-off vehicle operation DB 211 in which pickup and drop-off vehicle operation information indicating the operation status of a pickup and drop-off vehicle is recorded. The flight management system 200 receives flight reservation request information FTr transmitted from the user terminal 50 and accepts the reservation of a flight. The pickup and drop-off vehicle arrangement system 210 receives pickup and drop-off vehicle reservation request information TRr transmitted from the user terminal 50 and accepts the reservation of a pickup and drop-off vehicle.

The target vehicle 70 includes a control unit 71 that communicates with the vehicle management system 1 through the communication network 300 and a display 72 whose display content is controlled by the control unit 71. Note that when the target vehicle 70 does not include the onboard control unit 71 and display 72, a crew V may lend the driver D a portable control unit 75 having functions similar to those of the control unit 71 and the display 72 at the entrance gate 112 to allow for communication between the target vehicle 70 and the vehicle management system 1 by the control unit 75 and collect the control unit 75 at the exit gate 114.

A program 31 for controlling the vehicle management system 1 and an entering vehicle DB 32 in which information related to a vehicle that is permitted to enter the take-off and landing site 110 is recorded are saved in the memory 30. Identification information related to a vehicle that is permitted entry is recorded in the entering vehicle DB 32. As the identification information related to a vehicle, the registration number of the target vehicle 70, biometric information (such as a face image, an iris, or a fingerprint) related to the driver D, an authentication code set when a request of the entry of the target vehicle 70 to the take-off and landing site 110 is accepted, and the like are adopted in the examples of FIGS. 1 and 2.

The processor 10 reads and executes the program 31 to function as a vehicle entry acceptance section 11, a vehicle identification information obtaining section 12, a vehicle entry permission section 13, a vehicle-in-site monitoring section 14, a route information providing section 15, an entry-prohibited area information providing section 16, and a remote guide section 17.

Processing to be executed by the vehicle entry acceptance section 11 corresponds to a vehicle entry acceptance step in the vehicle management method according to the present disclosure and processing to be executed by the vehicle identification information obtaining section 12 corresponds to a vehicle identification information obtaining step in the vehicle management method according to the present disclosure. Processing to be executed by the vehicle entry permission section 13 corresponds to a vehicle entry permission step in the vehicle management method according to the present disclosure and processing to be executed by the vehicle-in-site monitoring section 14 corresponds to a vehicle-in-site monitoring step in the vehicle management method according to the present disclosure.

The vehicle entry acceptance section 11 receives vehicle entry request information BDr transmitted from the pickup and drop-off vehicle arrangement system 210 according to pickup and drop-off vehicle reservation request information TRr transmitted from the user terminal 50, thereby accepting a request of the entry of the target vehicle 70 to the take-off and landing site 110 for a transfer to the target flight FL. The pickup and drop-off vehicle reservation request information TRr includes the designation of a transfer to the flight FL in the take-off and landing site 110 and the pickup and drop-off vehicle reservation request information TRr in this case includes the vehicle entry request information according to the present disclosure. Note that when the user U has a family member or the like drive a vehicle owned by the user U and is picked up or dropped off at the take-off and landing site 110, the user U transmits the vehicle entry request information BDr to the vehicle management system 1 for requesting the entry of the owned vehicle.

The vehicle identification information obtaining section 12 obtains the identification information related to the target vehicle 70 included in the vehicle entry request information BDr and records the obtained identification information in the entering vehicle DB 32. When the vehicle entry permission section 13 recognizes a vehicle that arrives at the entrance gate on the basis of a shot image of the camera 113a (see FIG. 1) transmitted from the entrance gate unit 113, the vehicle entry permission section 13 performs authentication processing that uses the identification information related to the target vehicle 70 and recognizes whether or not the arrival vehicle is the target vehicle 70. When it is possible to confirm that the arrival vehicle is the target vehicle 70, the vehicle entry permission section 13 then opens the entrance gate 112 and permits the target vehicle 70 to enter the take-off and landing site 110.

The vehicle-in-site monitoring section 14 monitors the movement of the target vehicle 70 in the take-off and landing site 110 on the basis of positional information CPi related to the target vehicle 70 transmitted from the target vehicle 70 that enters the take-off and landing site 110. Note that the movement of the target vehicle 70 in the take-off and landing site 110 may be monitored on the basis of a shot image of a camera provided in the take-off and landing site 110, the reception status of the target vehicle 70 with respect to unique information transmitted from a beacon provided in the take-off and landing site 110, or the like instead of the positional information CPi transmitted from the target vehicle 70 or along with the positional information CPi.

The route information providing section 15 transmits, to the target vehicle 70, route information RTi indicating a route Ar1 (see FIG. 1) from the entrance gate 112 to the parking position Fs of the target aircraft 100 and from the parking position Fs to the exit gate 114. The entry-prohibited area information providing section 16 transmits, to the target vehicle 70, entry-prohibited area information EPi indicating the ranges of entry-prohibited areas Ar2 and Ar3 (see FIG. 1) other than the route Ar1 in the take-off and landing site 110.

When the target vehicle 70 is a self-driving vehicle, the remote guide section 17 guides the movement of the target vehicle 70 by self-driving from the entrance gate 112 to the parking position Fs of the target aircraft 100 and from the parking position Fs to the exit gate 114 through communication with the target vehicle 70. This case exhibits a manner in which, for example, the remote guide section 17 performs such a level of control as a route instruction or a traveling start and stop instruction on the target vehicle 70 that is a self-driving vehicle and the target vehicle 70 completes control on a specific operation system such as an accelerator, a brake, or steering by self-driving within the target vehicle 70 itself according to this control.

### 3. Vehicle Entry Management Processing

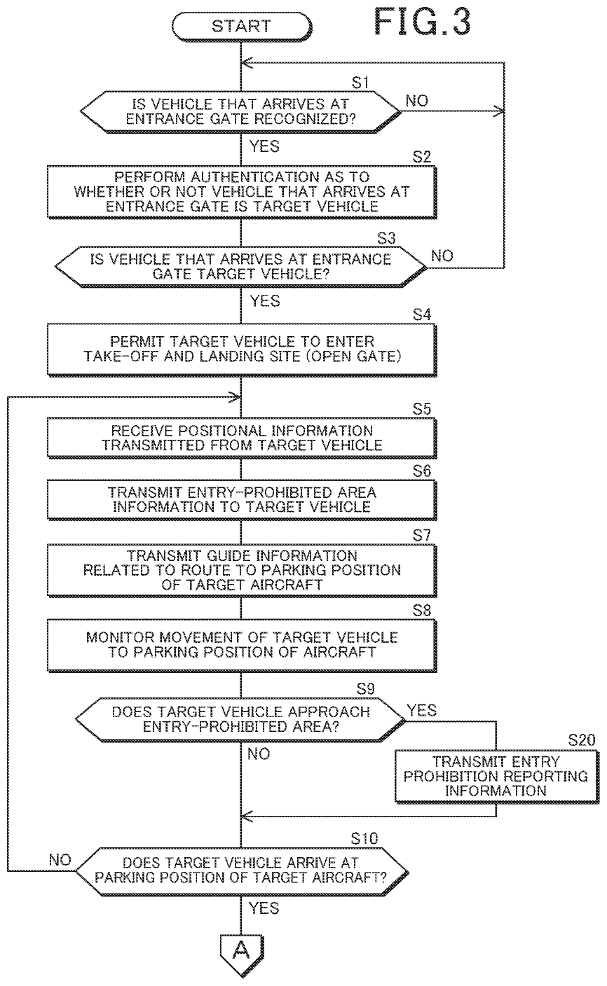

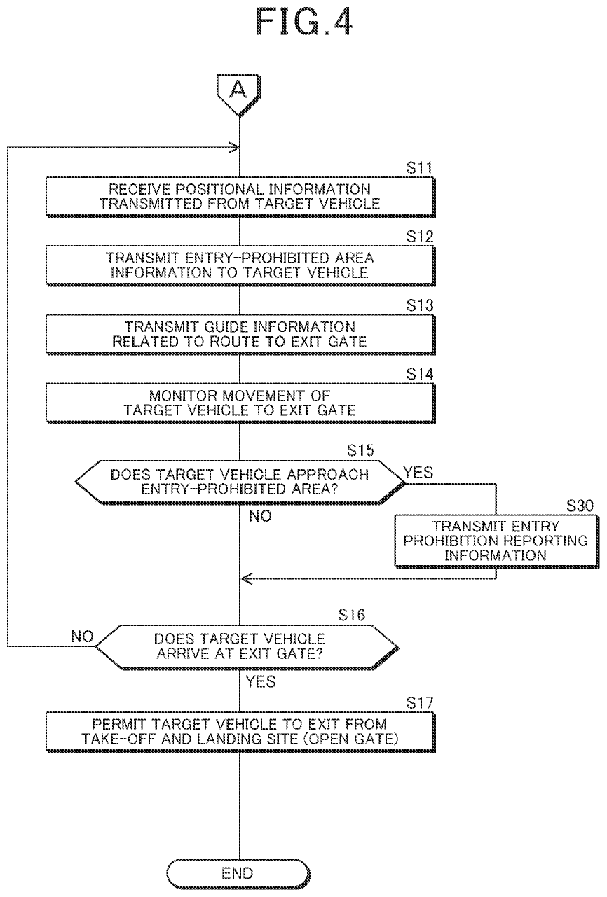

A procedure of the vehicle entry management processing to be executed by the vehicle management system 1 will be described in accordance with the flowcharts illustrated in FIGS. 3 and 4. When information related to the target vehicle 70 whose request to enter the take-off and landing site 110 is accepted for a transfer to the target flight FL is recorded in the entering vehicle DB 32, the vehicle management system 1 executes processing compliant with the flowcharts illustrated in FIGS. 3 and 4.

When the vehicle entry permission section 13 recognizes a vehicle that arrives at the entrance gate 112 on the basis of a shot image of the camera 113a transmitted from the entrance gate unit 113 in step S1 of FIG. 3, the vehicle entry permission section 13 advances the processing to step S2. In step S2, the vehicle entry permission section 13 performs authentication as to whether or not the vehicle that arrives at the entrance gate 112 is the target vehicle 70 by using the identification information related to the target vehicle 70 obtained by the vehicle identification information obtaining section 12.

The vehicle entry permission section 13 advances the processing to step S4 when the vehicle that arrives at the entrance gate 112 is the target vehicle 70 in subsequent step S3, and advances the processing to step S1 when the vehicle that arrives at the entrance gate 112 is not the target vehicle 70 in step S3. In step S4, the vehicle entry permission section 13 transmits gate open instruction information to the entrance gate unit 113 and causes the entrance gate unit 113 to open the entrance gate 112, thereby permitting the target vehicle 70 to enter the take-off and landing site 110. This causes the driver D to drive the target vehicle 70 into the take-off and landing site 110.

Here, when the driver D of the target vehicle 70 permits the positional information to be provided, the vehicle entry permission section 13 may cause the entrance gate 112 to be opened. The permission to provide the positional information by the driver D includes performing an operation of permitting positional information detected by a position detection sensor such as a global positioning system (GPS) sensor mounted on the target vehicle 70 to be transmitted from the target vehicle 70 to the vehicle management system 1 or an operation of permitting the vehicle-in-site monitoring section 14 to monitor the position of the target vehicle 70 on the basis of a shot image of a camera installed in the take-off and landing site 110.

Through the loop processing in next steps S5 to S10 and step S20, the vehicle-in-site monitoring section 14 monitors the movement of the target vehicle 70 in the take-off and landing site 110 until the vehicle-in-site monitoring section 14 recognizes that the target vehicle 70 arrives at the parking position Fs of the target aircraft 100 in step S10. In step S5, the vehicle-in-site monitoring section 14 receives and obtains the positional information transmitted from the target vehicle 70.

In subsequent step S6, the entry-prohibited area information providing section 16 transmits the entry-prohibited area information EPi to the target vehicle 70. The control unit 71 that receives the entry-prohibited area information EPi displays a guide screen indicating the ranges of the entry-prohibited areas Ar2 and Ar3 on the display 72 in the target vehicle 70.

In next step S7, the route information providing section 15 transmits, to the target vehicle 70, the route information RTi indicating a route to the parking position Fs of the target aircraft 100. The control unit 71 that receives the route information RTi displays a guide screen indicating the route to the parking position Fs on the display 72 in the target vehicle 70. Note that the route guidance may be given by outputting sound.

The vehicle-in-site monitoring section 14 monitors the movement of the target vehicle 70 to the parking position Fs in next step S8 and determines in step S9 whether or not the target vehicle 70 approaches the entry-prohibited area Ar2 or Ar3. The vehicle-in-site monitoring section 14 then advances the processing to step S20 when the target vehicle 70 approaches the entry-prohibited area Ar2 or Ar3, and advances the processing to step S10 when the target vehicle 70 does not approach the entry-prohibited areas Ar2 and Ar3.

In step S20, the vehicle-in-site monitoring section 14 transmits entry prohibition reporting information to the target vehicle 70 and advances the processing to step S10. In the target vehicle 70, the control unit 71 that receives the entry prohibition reporting information displays a screen reporting that an entry-prohibited area is approached, thereby prompting the driver D to get away from the entry-prohibited areas Ar2 and Ar3.

The vehicle-in-site monitoring section 14 advances the processing to step S10 of FIG. 4 when the vehicle-in-site monitoring section 14 recognizes the arrival at the parking position Fs of the target aircraft 100 in step S10 on the basis of the positional information transmitted from the target vehicle 70, and advances the processing to step S5 when the target vehicle 70 does not arrive at the parking position Fs.

Through the loop processing in steps S11 to S16 and step S30 of FIG. 4, the vehicle-in-site monitoring section 14 monitors the movement of the target vehicle 70 in the take-off and landing site 110 until the vehicle-in-site monitoring section 14 confirms that the target vehicle 70 arrives at the exit gate 114 of the take-off and landing site 110 in step S16. In step S11, the vehicle-in-site monitoring section 14 receives and obtains the positional information transmitted from the target vehicle 70.

In subsequent step S12, the entry-prohibited area information providing section 16 transmits the entry-prohibited area information EPi to the target vehicle 70. The control unit 71 that receives the entry-prohibited area information EPi displays a guide screen indicating the ranges of the entry-prohibited areas Ar2 and Ar3 on the display 72 in the target vehicle 70.

In next step S13, the route information providing section 15 transmits, to the target vehicle 70, the route information RTi indicating a route to the exit gate 114 of the take-off and landing site 110. The control unit 71 that receives the route information RTi displays a guide screen indicating the route to the exit gate 114 on the display 72 in the target vehicle 70. Note that the route guidance may be given by outputting sound.

The vehicle-in-site monitoring section 14 monitors the movement of the target vehicle 70 to the exit gate 114 in next step S14 and determines in step S15 whether or not the target vehicle 70 approaches the entry-prohibited area Ar2 or Ar3. The vehicle-in-site monitoring section 14 then advances the processing to step S30 when the target vehicle 70 approaches the entry-prohibited area Ar2 or Ar3, and advances the processing to step S16 when the target vehicle 70 does not approach the entry-prohibited areas Ar2 and Ar3.

In step S30, the vehicle-in-site monitoring section 14 transmits entry prohibition reporting information to the target vehicle 70 and advances the processing to step S16. In the target vehicle 70, the control unit 71 that receives the entry prohibition reporting information displays a screen reporting that an entry-prohibited area is approached, thereby prompting the driver D to get away from the entry-prohibited areas Ar2 and Ar3.

The vehicle-in-site monitoring section 14 advances the processing to step S17 when the vehicle-in-site monitoring section 14 recognizes that the target vehicle 70 arrives at the exit gate 114 in step S16 on the basis of the positional information transmitted from the target vehicle 70, and advances the processing to step S11 when the target vehicle 70 does not arrive at the exit gate 114.

In step S17, the vehicle-in-site monitoring section 14 transmits gate open instruction information to the exit gate unit 115 and causes the exit gate unit 115 to open the exit gate 114, thereby allowing the target vehicle 70 to exit from the take-off and landing site 110. This causes the driver D to drive the target vehicle 70 and exit from the take-off and landing site 110.

### 4. Other Embodiments

In the embodiment described above, the route information providing section 15 is included and the route information RTi is transmitted to the target vehicle 70 that moves in the take-off and landing site 110, but a configuration in which the route information providing section 15 is omitted may be adopted.

In the embodiment described above, the entry-prohibited area information providing section 16 is included and the entry-prohibited area information EPi is transmitted to the target vehicle 70 that moves in the take-off and landing site 110, but a configuration in which the entry-prohibited area information providing section 16 is omitted may be adopted.

In the embodiment described above, the remote guide section 17 is included and the movement of a vehicle in the take-off and landing site 110 by self-driving is supported, but a configuration in which the remote guide section 17 is omitted may be adopted.

In the embodiment described above, a report is made to attract the attention of the driver D of the target vehicle 70 through the processing in step S9 and step S20 of FIG. 3 and step S15 and step S30 of FIG. 4 when the target vehicle 70 approaches the entry-prohibited area Ar2 or Ar3. As another embodiment, a report may be made to attract the attention of the driver D when the target vehicle 70 deviates by a predetermined distance or more from the route Ar1 from the entrance gate 112 to the parking position Fs of the target aircraft 100 and from the parking position Fs to the exit gate 114.

In the embodiment described above, the case has been described where the vehicle management system 1 monitors the entry of the one target vehicle 70 to the take-off and landing site 110. As another embodiment, the vehicle management system 1 is also capable of monitoring the entry of each of the two or more target vehicles 70 to the take-off and landing site 110. In this case, countermeasures may be taken from the perspective of safety such as making a report more strictly to pay attention to a deviation from the route Ar1 defined in advance or causing the remote guide section 17 to guide the movement of each of the target vehicles 70 while essentially requiring the target vehicle to have a self-driving function.

Note that FIG. 2 is a schematic diagram in which the functional components of the vehicle management system 1 are divided according to the chief processing contents for facilitating the understanding of the invention according to the present application. The components of the vehicle management system 1 may be configured according to other divisions. In addition, the processing of each of the components may be executed by one hardware unit or executed by a plurality of hardware units. In addition, the processing by each of the components illustrated in any of FIGS. 3 and 4 may be executed by one program or executed by a plurality of programs.

### 5. Configurations Supported by Embodiments Above

The embodiments described above are specific examples of the following configurations.

(Configuration 1) A vehicle management system including: a vehicle entry acceptance section configured to receive vehicle entry request information transmitted from a user terminal that is used by a user who reserves a target flight and accept entry of a target vehicle to a take-off and landing site of the target flight, the vehicle entry request information being for requesting the entry of the target vehicle to the take-off and landing site; a vehicle identification information obtaining section configured to obtain vehicle identification information when the vehicle entry acceptance section accepts the entry of the target vehicle to the take-off and landing site, the vehicle identification information being for identifying the target vehicle; a vehicle entry permission section configured to permit the target vehicle to enter the take-off and landing site when arrival of the target vehicle at a vehicle entrance gate in the take-off and landing site is recognized through authentication processing that uses the vehicle identification information; and a vehicle-in-site monitoring section configured to recognize a position of the target vehicle in the take-off and landing site and monitor movement of the target vehicle to a parking position of a target aircraft that is used for the target flight.

The vehicle management system according to Configuration 1 permits the entry of the target vehicle to the take-off and landing site of the target flight in accordance with a request of the user who reserves the target flight under the conditions that the target vehicle is authenticated and the movement to the parking position of the target aircraft in the take-off and landing site is monitored. This makes it possible to support an efficient transfer between an aircraft and a vehicle.

(Configuration 2) The vehicle management system according to Configuration 1, in which the vehicle-in-site monitoring section monitors the movement of the target vehicle to the parking position of the target aircraft on the basis of positional information related to the target vehicle, the positional information being transmitted from the target vehicle.

The vehicle management system according to Configuration 2 makes it possible to monitor a movement status of the target vehicle in the take-off and landing site by using the positional information related to the target vehicle.

(Configuration 3) The vehicle management system according to any one of Configurations 1 to 3, including a route information providing section configured to transmit route information to the target vehicle that enters the take-off and landing site, the route information being related to a route to the parking position of the target aircraft.

The vehicle management system according to Configuration 3 makes it possible to guide a driver of the target vehicle along the route to the parking position of the target aircraft in the take-off and landing site.

(Configuration 4) The vehicle management system according to any one of Configurations 1 to 3, including an entry-prohibited area information providing section configured to transmit information to the target vehicle that enters the take-off and landing site, the information being related to an entry-prohibited area for the target vehicle in the take-off and landing site.

The vehicle management system according to Configuration 4 makes it possible to prevent the target vehicle from entering the entry-prohibited area by transmitting entry-prohibited area information to the target vehicle.

(Configuration 5) The vehicle management system according to any one of Configurations 1 to 4, in which, when the target vehicle that enters the take-off and landing site approaches an entry-prohibited area for the target vehicle in the take-off and landing site, the vehicle-in-site monitoring section transmits entry prohibition reporting information to the target vehicle, the entry prohibition reporting information being for reporting prohibition of entry to the entry-prohibited area.

The vehicle management system according to Configuration 5 makes it possible to prevent the target vehicle from entering the entry-prohibited area by reporting, to the driver of the target vehicle, that the entry-prohibited area is approached.

(Configuration 6) The vehicle management system according to any one of Configurations 1 to 5, in which the target vehicle has a self-driving function, and the vehicle management system includes a remote guide section configured to guide the target vehicle that enters the take-off and landing site to the parking position of the target aircraft by self-driving.

The vehicle management system according to Configuration 6 allows the target vehicle having the self-driving function to move to the parking position of the target aircraft more reliably.

(Configuration 7) A vehicle management method that is executed by a computer, the vehicle management method including: a vehicle entry acceptance step of receiving vehicle entry request information transmitted from a user terminal that is used by a user who reserves a target flight and accepting entry of a target vehicle to a take-off and landing site of the target flight, the vehicle entry request information being for requesting the entry of the target vehicle to the take-off and landing site; a vehicle identification information obtaining step of obtaining vehicle identification information when the entry of the target vehicle to the take-off and landing site is accepted in the vehicle entry acceptance step, the vehicle identification information being for identifying the target vehicle; a vehicle entry permission step of permitting the target vehicle to enter the take-off and landing site when arrival of the target vehicle at a vehicle entrance gate in the take-off and landing site is recognized through authentication processing that uses the vehicle identification information; and a vehicle-in-site monitoring step of recognizing a position of the target vehicle in the take-off and landing site and monitoring movement of the target vehicle to a parking position of a target aircraft that is used for the target flight.

The execution of the vehicle management method according to Configuration 7 by the computer makes it possible to obtain the workings and effects similar to those of the vehicle management system according to Configuration 1.

### REFERENCE SIGNS LIST

1 vehicle management system
10 processor
11 vehicle entry acceptance section
12 vehicle identification information obtaining section
13 vehicle entry permission section
14 vehicle-in-site monitoring section
15 route information providing section
16 entry-prohibited area information providing section
17 remote guide section
30 memory
31 program
32 entering vehicle DB
50 user terminal
70 target vehicle
71 control unit
72 display
75 control unit
100 target aircraft
110 take-off and landing site
112 entrance gate
113 entrance gate unit
114 exit gate
115 exit gate unit
200 flight management system
201 flight operation DB
210 pickup and drop-off vehicle arrangement system
211 pickup and drop-off vehicle operation DB
300 communication network
U user
D driver
V crew

What is claimed is:

1. A vehicle management system comprising:
a vehicle entry acceptance section configured to receive vehicle entry request information transmitted from a user terminal that is used by a user who reserves a target flight and accept entry of a target vehicle to a take-off and landing site of the target flight, the vehicle entry request information being for requesting the entry of the target vehicle to the take-off and landing site;
a vehicle identification information obtaining section configured to obtain vehicle identification information when the vehicle entry acceptance section accepts the entry of the target vehicle to the take-off and landing site, the vehicle identification information being for identifying the target vehicle;
a vehicle entry permission section configured to permit the target vehicle to enter the take-off and landing site when arrival of the target vehicle at a vehicle entrance gate in the take-off and landing site is recognized through authentication processing that uses the vehicle identification information; and
a vehicle-in-site monitoring section configured to recognize a position of the target vehicle in the take-off and landing site and monitor movement of the target vehicle to a parking position of a target aircraft that is used for the target flight.

2. The vehicle management system according to claim 1, wherein the vehicle-in-site monitoring section monitors the movement of the target vehicle to the parking position of the target aircraft on a basis of positional information related to the target vehicle, the positional information being transmitted from the target vehicle.

3. The vehicle management system according to claim 1, comprising a route information providing section configured to transmit route information to the target vehicle that enters the take-off and landing site, the route information being related to a route to the parking position of the target aircraft.

4. The vehicle management system according to claim 1, comprising an entry-prohibited area information providing section configured to transmit information to the target vehicle that enters the take-off and landing site, the information being related to an entry-prohibited area for the target vehicle in the take-off and landing site.

5. The vehicle management system according to claim 1, wherein, when the target vehicle that enters the take-off and landing site approaches an entry-prohibited area for the target vehicle in the take-off and landing site, the vehicle-in-site monitoring section transmits entry prohibition reporting information to the target vehicle, the entry prohibition reporting information being for reporting prohibition of entry to the entry-prohibited area.

6. The vehicle management system according to claim 1, wherein
the target vehicle has a self-driving function, and
the vehicle management system comprises a remote guide section configured to guide the target vehicle that enters the take-off and landing site to the parking position of the target aircraft by self-driving.

7. A vehicle management method that is executed by a computer, the vehicle management method comprising:
a vehicle entry acceptance step of receiving vehicle entry request information transmitted from a user terminal that is used by a user who reserves a target flight and accepting entry of a target vehicle to a take-off and landing site of the target flight, the vehicle entry request information being for requesting the entry of the target vehicle to the take-off and landing site;
a vehicle identification information obtaining step of obtaining vehicle identification information when the entry of the target vehicle to the take-off and landing site is accepted in the vehicle entry acceptance step, the vehicle identification information being for identifying the target vehicle;
a vehicle entry permission step of permitting the target vehicle to enter the take-off and landing site when arrival of the target vehicle at a vehicle entrance gate in the take-off and landing site is recognized through authentication processing that uses the vehicle identification information; and
a vehicle-in-site monitoring step of recognizing a position of the target vehicle in the take-off and landing site and monitoring movement of the target vehicle to a parking position of a target aircraft that is used for the target flight.
